(19) United States
(12) Patent Application Publication
(10) Pub. No.: US 2025/0169392 A1
(43) Pub. Date: May 29, 2025

(54) Row Unit for Agricultural Implement, Agricultural Implement Comprising Closing Wheel and Method of Adjusting Closing Wheel

(71) Applicant: Väderstad Holding AB, Väderstad (SE)

(72) Inventors: Bengt Sandberg, Vikingstad (SE); Rune Rommedahl, Ljungsbro (SE); Crister Stark, Väderstad (SE)

(21) Appl. No.: 18/719,920

(22) PCT Filed: Dec. 15, 2022
(86) PCT No.: PCT/EP2022/086126

§ 371 Date: Jun. 14, 2024

(30) Foreign Application Priority Data
Dec. 16, 2021 (SE) 2151544-0

(51) Int. Cl. A01C 5/06

(52) U.S. Cl. CPC A01C 5/068; A01C 5/062

(57) ABSTRACT

A row unit (110) for an agricultural implement, comprises a row unit frame (111, 112), at least one furrow opener (113), supported by the row unit frame (111, 112), and at least one closing wheel (117), supported by the row unit frame (111, 112). The closing wheel (117) is rotatably mounted to a closing wheel frame (118) about a geometric rotation axis (Aw). The closing wheel (118) frame is pivotably mounted to the row unit frame (111, 112). The closing wheel frame (118) is pivotably mounted to the row unit frame (111, 112) such that the closing wheel frame (118) is pivotable about a geometric pivot axis (Ap) which is inclined relative to a vertical direction. Also disclosed is an agricultural implement comprising a plurality of such row units, as well as a method of adjusting an orientation of a closing wheel.

### TECHNICAL FIELD

The present disclosure relates to a row unit for an agricultural implement for distribution of granular material to ground over which the agricultural implement travels. The disclosure further relates to an agricultural implement comprising such row units.

Such agricultural implements may be provided in the form of seeders or planters. However, the invention may also find use in other form of agricultural implements, such as in distributors for granular fertilizer and/or pesticide.

### BACKGROUND

In connection with seeding or planting, it is desirable to achieve optimal conditions for the seed to germinate and not to become feed for birds. This includes properly closing the seed furrow. For a closing to be effective, it is desirable to provide a combination of downforce and operating angle for the device, which may have the form of a closing wheel.

What constitutes an optimal operating angle for the closing wheel depends on soil quality and other soil conditions, such as whether the soil has been recently worked or not. A very hard soil, e.g. with high clay content, may require aggressive action from the closing wheel. On the other hand, when the soil is very soft, which it may be when it has recently been worked, a closing wheel may be too aggressive and, in a worst case scenario, may even dig up seeds which have just been sown. Instead, in such conditions, it may not be necessary to actively close the furrow at all, as soft soil may fall back into the furrow merely by gravity, thereby closing it. The closing wheel may also assist in the reconsolidation of the soil, thus enhancing the contact between the soil and the seed.

Hence, there is a desire to adjust the closing wheel to achieve an optimal working angle.

A solution for such adjustment is disclosed in WO2016/166727A1.

However, there is a need for improved solutions for adjusting the closing wheel working angle.

### SUMMARY

It is an object of the present disclosure to provide a row unit having an improved adjustable closing wheel. A particular object is to provide a solution which reduces the amount of work in adjusting the closing wheel, which is of particular importance on very large agricultural implements, which may comprise a large number of row units, each having a respective closing wheel.

The invention is defined by the appended independent claims, with embodiments being set forth in the dependent claims, in the following description and in the attached drawings.

According to a first aspect, there is provided a row unit for an agricultural implement, comprising a row unit frame, at least one furrow opener, supported by the row unit frame, and at least one closing wheel, supported by the row unit frame. The closing wheel is rotatably mounted to a closing wheel frame about a geometric rotation axis. The closing wheel frame is pivotably mounted to the row unit frame. The closing wheel frame is pivotably mounted to the row unit frame such that the closing wheel frame is pivotable about a geometric pivot axis which is inclined relative to a vertical direction.

The term “inclined” means an angle greater than 0 degrees and less than 90 degrees.

By pivoting the closing wheel about an inclined geometric pivot axis, and in particular a single geometric pivot axis, it is possible to adjust the setting, and thus the action, of the closing wheel while keeping it in line with the remainder of the row unit and while obtaining an optimal working angle for the closing wheel.

The geometric pivot axis may be inclined such that, when the row unit is positioned on a horizontal surface and the closing wheel rests on said surface, an extension of the geometric pivot axis intersects the horizontal surface at a position which approximately coincides with a contact point between the closing wheel and the horizontal surface.

Consequently, when the closing wheel frame is pivoted about the geometric pivot axis, the closing wheel will essentially retain its lateral position, which may be behind forwardly positioned parts of the row unit, in particular the furrow opener, gauge wheel and press wheel, if any.

The intersection point may be positioned laterally of and/or forwardly of the contact point.

The intersection point may be positioned at a distance from the contact point, which is equal to or less than an 150% of an axial width of the closing wheel, preferably less than or equal to 100% of said axial width, less than or equal to 50% of said axial width or less than or equal to 10% of said axial width.

The intersection point may be within a radius of less than 100 mm, preferably less than 70 mm, less than 50 mm or less than 25 mm, from the contact point.

The geometric pivot axis may provide an angle of 5-60 degrees to a vertical direction, preferably 5-50 degrees or 10-40 degrees.

In particular, the angle may be in an interval selected from a group consisting of 5-10 degrees, 10-15 degrees, 15-20 degrees, 20-25 degrees, 25-30 degrees, 30-35 degrees, 35-40 degrees, 40-45 degrees, 45-50 degrees, 50-55 degrees and 55-60 degrees.

The geometric pivot axis may be positioned in a first vertical plane which is parallel with a working direction of the row unit.

A second plane which is perpendicular to the first vertical plane, and which contains the geometric pivot axis, ma be positioned rearwardly of an intersection of the geometric rotation axis and the closing wheel.

The closing wheel may be positionable in a first position wherein the closing wheel is rotatable in a vertical plane which contains a working direction of the row unit.

The row unit may further comprise a locking device for releasably locking the closing wheel frame relative to the row unit frame in at least two predetermined relative positions.

The row unit may further comprise a connecting frame for connecting the closing wheel frame to the row unit frame.

The closing wheel frame may further comprises a handle for adjusting the position of the closing wheel.

The closing wheel frame may be pivotably mounted to the row unit frame at a pivot joint which is positioned rearwardly of the geometric rotation axis.

The geometric pivot axis may be inclined such that a vertically upper portion of the geometric pivot axis is positioned horizontally rearwardly in the working direction of a vertically lower portion of the geometric pivot axis.

The closing wheel frame may be pivotably mounted to the row unit frame at a pivot joint which is positioned forwardly of the geometric rotation axis.

The geometric pivot axis may be inclined such that a vertically upper portion of the geometric pivot axis is positioned horizontally forwardly in the working direction of a vertically lower portion of the geometric pivot axis.

According to a second aspect, there is provided an agricultural implement for distribution of granular material to ground over which the implement travels, comprising an implement frame, and a plurality of row units as described above, said row units being supported by the implement frame.

According to a third aspect, there is provided a method of adjusting an orientation of a closing wheel in row unit as described above, the method comprising releasing a locking mechanism, adjusting the orientation of the closing wheel by pivoting the closing wheel frame about the geometric pivot axis, and subsequently engaging the locking mechanism.

### BRIEF DESCRIPTION OF THE DRAWINGS

FIG. 1 schematically illustrates an agricultural implement in the form of a seeder.

FIG. 2 schematically illustrates a plurality of row units, which may form part of such a seeder.

FIGS. 3a-3c schematically illustrate a row unit as seen in a side view and in a top view, respectively, with a first closing wheel setting.

FIGS. 4a-4c schematically illustrate the row unit as seen in a side view and in a top view, respectively, with a second closing wheel setting.

FIG. 5 schematically illustrates an adjustment device for the closing wheel.

FIG. 6 schematically illustrates an alternative adjustment device for the closing wheel.

FIG. 7 schematically illustrates a plurality of row units according to another embodiment, which may form part of such a seeder.

FIG. 8 schematically illustrates two row units in a side view according to another embodiment, which may form part of such a seeder.

FIGS. 9a-9b schematically illustrate a row unit according to another embodiment as seen in a side view and in a view from behind.

### DETAILED DESCRIPTION

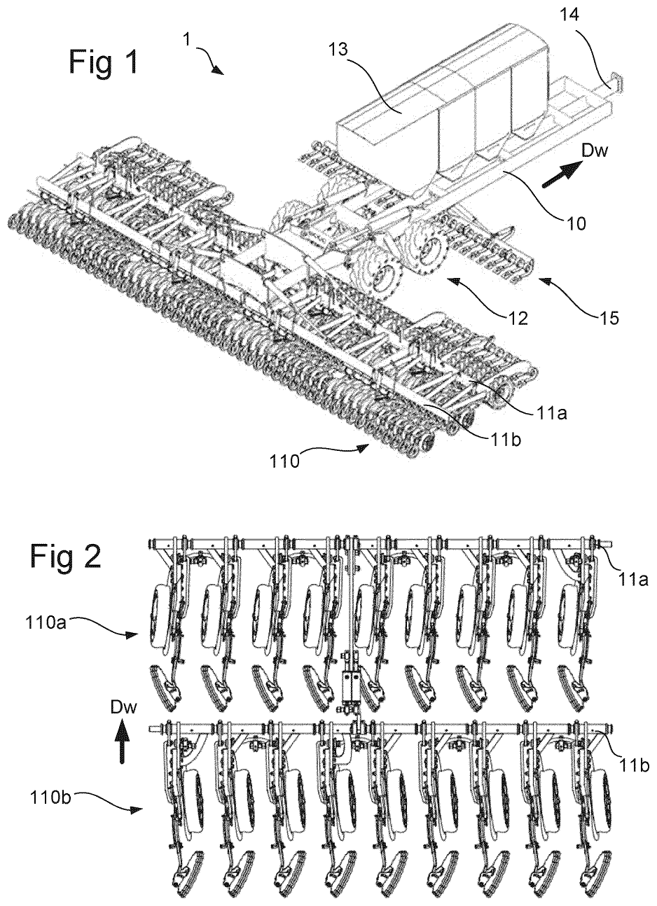

FIG. 1 schematically illustrates an agricultural implement 1 in the form of a seeder.

It is understood that, while the present inventive concept is illustrated with reference to a seeder, it is applicable also to other types of agricultural implements, including planters, as well as other types of implements for distributing granular and/or liquid material to ground over which the implement travels. Such material may in particular comprise seeds, fertilizer and/or pesticide.

The agricultural implement 1 may comprise a main frame part 10 and one or more transverse frame parts 11a, 11b. Such transverse frame parts may be formed in one or more parts, which may be movable, such as pivotable, relative to each other in order to allow for the agricultural implement to be transformed between a working state, wherein the transverse frame parts 11a, 11b may be extended to their full width, and a road transport state, wherein the transverse frame parts 11a, 11b may be folded such that the width and/or height of the agricultural implement 1 makes it suitable for road transport.

A plurality of row units 110 may be supported by the main frame part and/or by the transverse frame parts 11a, 11b. The row units 110 may be substantially identical with each other.

The agricultural implement 1 may also comprise one or more support wheels 12, one or more hoppers 13 for holding the material that is to be distributed by the agricultural implement 1, a tow bar 14 for connection to a traction vehicle, such as a tractor, and one or more sets of ground working tools 15, such as, but not limited to, levelling tools, cultivating tools or packing tools.

FIG. 2 schematically illustrates a portion of the transverse frame parts 11a, 11b which support respective sets of row units 110a, 110b, including a front frame parts 11a and a rear frame part 11b.

As can be seen from FIG. 2, the row units 110b supported by the rear frame part 11b are mirror inverted relative to the row units 110a supported by the front frame part 11a.

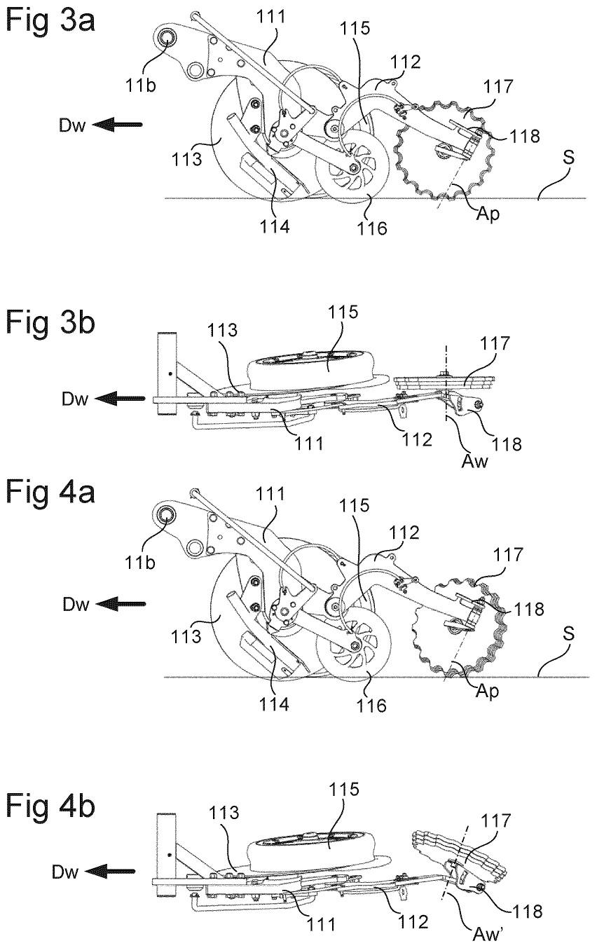

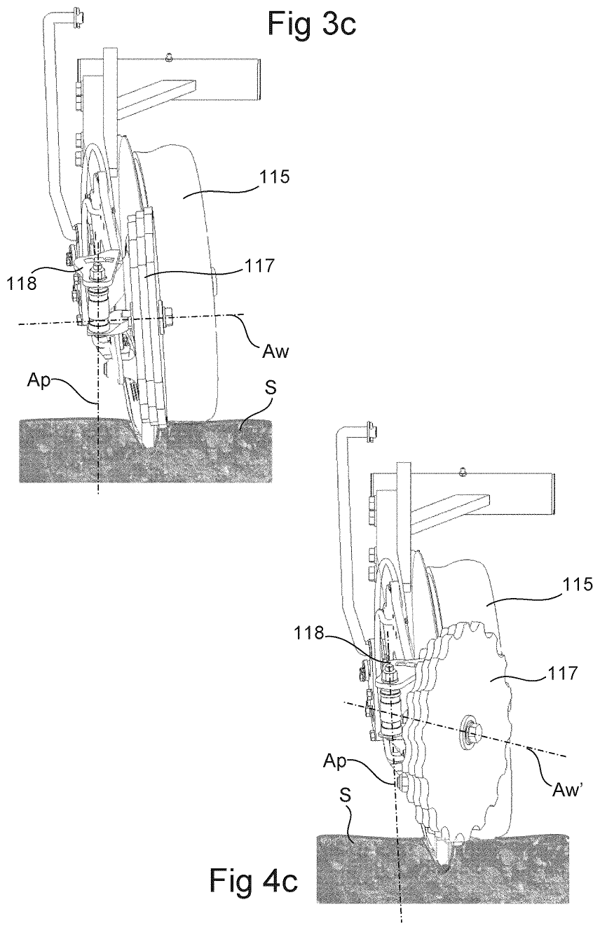

FIGS. 3a-3b schematically illustrate a row unit 110b configured for the rear frame part 11b, in which a closing wheel 117 is in a position that is suitable for operation on very soft soil. In this position, the closing wheel 117 merely rolls on the soil, for example along a line which coincides with the seed furrow, in which case the closing wheel 117 acts to provide reconsolidation of the soil.

The row unit 110b comprises a row unit frame 111, 112, which may comprise a single frame part or a pair of frame parts 111, 112 which may be movably connected to each other, as is illustrated in FIGS. 3a-3b, where the row unit frame comprises a first row unit frame part 111, which is connected to the transverse frame part 11b and which may carry a furrow opener 113, a seed outlet 114, a gauge wheel 115 and a press wheel 116. A second row unit frame part 112 may be pivotably connected to the first row unit frame part 111 and may carry a closing wheel 117.

The closing wheel 117 is supported by a closing wheel frame 118, which is pivotably connected to the row unit frame 111, 112 such that the closing wheel frame 118 is pivotable relative to the row unit frame 111, 112 about a geometric pivot axis Ap, which is inclined relative to a vertical direction. The closing wheel 117 is rotatably connected to the closing wheel frame 118, such that the closing wheel 117 is rotatable about a geometric closing wheel axis Aw.

As can be seen in FIGS. 3a-3b, the wheel axis, in this position is substantially horizontal and substantially perpendicular to the working direction Dw.

As can be seen in FIGS. 3a-3b, the geometric pivot axis Ap is inclined relative to a vertical direction when the row unit is positioned on a horizontal surface.

In particular, the geometric pivot axis Ap may be inclined such that, when the row unit 110a, 110b is positioned on a horizontal surface S and the closing wheel 117 rests on said surface S, an extension of the geometric pivot axis Ap intersects the horizontal surface S at a position which approximately coincides with a contact point between the closing wheel 117 and the horizontal surface S.

Consequently, when the closing wheel frame 118 is pivoted about the geometric pivot axis Ap, the closing wheel will essentially retain its position behind forwardly oriented parts of the row unit 110a, 110b, in particular the furrow opener 113, gauge wheel 115 and press wheel 116, if any.

The intersection point may be positioned at a distance from the contact point, which may be equal to or less than an 150% of an axial width of the closing wheel, preferably less than or equal to 100% of said axial width, less than or equal to 50% of said axial width or less than or equal to 10% of said axial width.

The intersection point may be positioned slightly laterally of and/or forwardly of the contact point. That is, the intersection point should be positioned such that the closing wheel 117 does not move forwardly when it is adjusted.

The geometric pivot axis may provide an angle of 5-60 degrees to a vertical direction, preferably 5-50 degrees or 10-40 degrees.

In particular, the angle may be in an interval selected from a group consisting of 5-10 degrees, 10-15 degrees, 15-20 degrees, 20-25 degrees, 25-30 degrees, 30-35 degrees, 35-40 degrees, 40-45 degrees, 45-50 degrees, 50-55 degrees and 55-60 degrees.

As can be seen in FIGS. 3a-3c, and in particular in FIG. 3c, the closing wheel 117 is positioned with its axis of rotation Aw perpendicular to the working direction Dw, such that it rolls over at least part of the furrow formed in the soil S, and thus reconsolidates soil that has fallen into the furrow.

FIGS. 4a-4b schematically illustrate the row unit 110b configured for the rear frame part 11b, in which the closing wheel 117 is in a position that is suitable for operation on very hard soil.

As can be seen in FIGS. 4a-4b, in this position, the wheel axis Aw′ is inclined upwardly in the working direction Dw. The wheel axis Aw′ is also inclined as seen in a horizontal plane, such that it is no longer perpendicular to the working direction Dw.

As can be seen in FIGS. 4a-4c, and in particular in FIG. 4c, the closing wheel 117 is positioned such that its axis of rotation Aw′ is non-perpendicular to the working direction Dw, while the closing wheel 117 still engages the soil at approximately the same point, as seen in the lateral direction, perpendicular to the working direction D2, and thus pushes soil into the furrow.

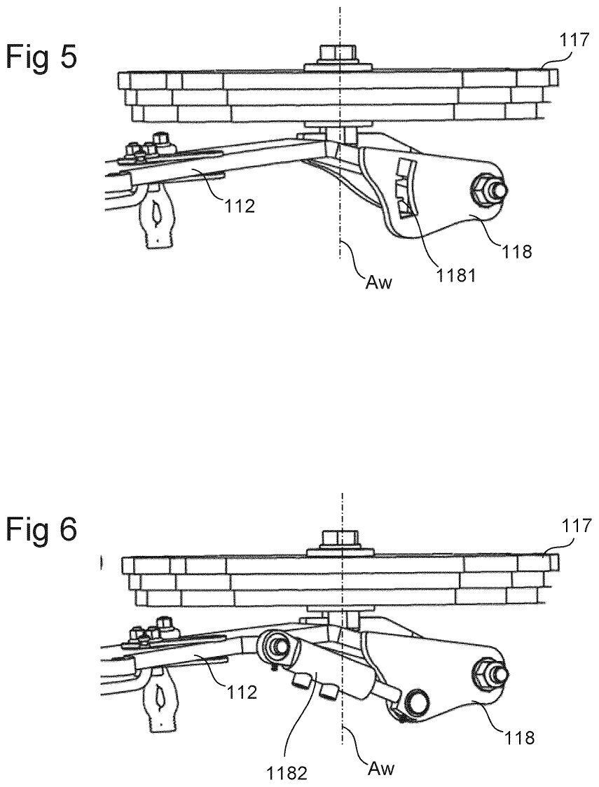

Referring to FIG. 5, there is illustrated an embodiment of a row unit, wherein the relative position of the row unit frame 112 and the closing wheel frame 118 is manually adjustable.

While it is possible to provide manually adjustable embodiment which are continuously adjustable between a pair of extreme positions, the illustrated embodiment provides a limited number of predetermined positions, such as three. The number of predetermined positions may be two, three, four or more, as desired. A locking member 1181, which may be spring loaded, can be provided for engagement with one of the predetermined positions. Hence, adjustment can be performed by manually moving the locking member out of engagement with the predetermined position, pivoting the closing wheel frame 118 relative to the row unit frame 111, 112 and then allowing the locking member to engage another one of the predetermined positions.

Referring to FIG. 6, there is illustrated an embodiment of a row unit, wherein the relative position of the row unit frame 112 and the closing wheel frame 118 is adjustable by means of an actuator 1182, which is configured to act between the row unit frame 111, 112 and the closing wheel frame 118.

The actuator 1182 may be a hydraulic, pneumatic or electric actuator, which may be controllable from a central controller (not shown) of the agricultural implement 1 or of a traction vehicle (not shown).

The controller and actuator 1182 may be configured to provide a plurality of preprogrammed positions, or a continuum of positions.

For example, the actuator 1182 may be individually controllable from the central controller, e.g. in response to an observed result at the individual row unit or in response to an observed result of a group of adjacent row units.

As another example, the actuators 1182 of all of the row units of the agricultural implement, or of a group of row units, may be controllable in response to an observed result of all of the row units of the agricultural implement or of a group of adjacent row units.

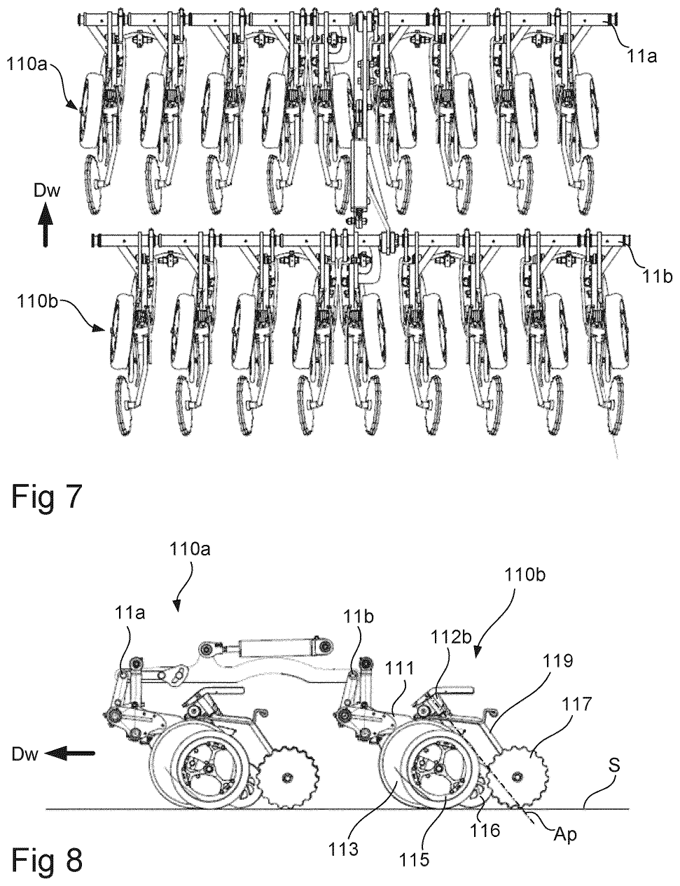

Referring to FIGS. 7-9, there is illustrated an embodiment of a row unit having a pivot axis Ap which is inclined forwardly in a working direction relative to a vertical direction when the row unit is positioned on a horizontal surface. That is, the pivot axis is inclined such that a vertically higher situated portion of the pivot axis will be situated forwardly of a vertically lower situated portion of the pivot axis, as seen in the working direction Dw of the agricultural implement. The closing wheel 117 has a closing wheel frame 119 extending to a connecting frame 1192, 1193 which connects the closing wheel arm 119 to the row unit frame part 111.

FIG. 7 schematically illustrates a portion of the transverse frame parts 11a, 11b, according to this embodiment, which support respective sets of row units 110a, 110b, including a front frame parts 11a and a rear frame part 11b.

As can be seen from FIG. 7, the row units 110b supported by the rear frame part 11b are mirror inverted relative to the row units 110a supported by the front frame part 11a.

FIG. 8 further illustrates two row units 110a, 110b. The row unit 110a is supported by the front frame part 11a and the row unit 110b is supported by the rear frame part 11b. The front frame part 11a and the rear frame part 11b are connected by a longitudinally extending frame part.

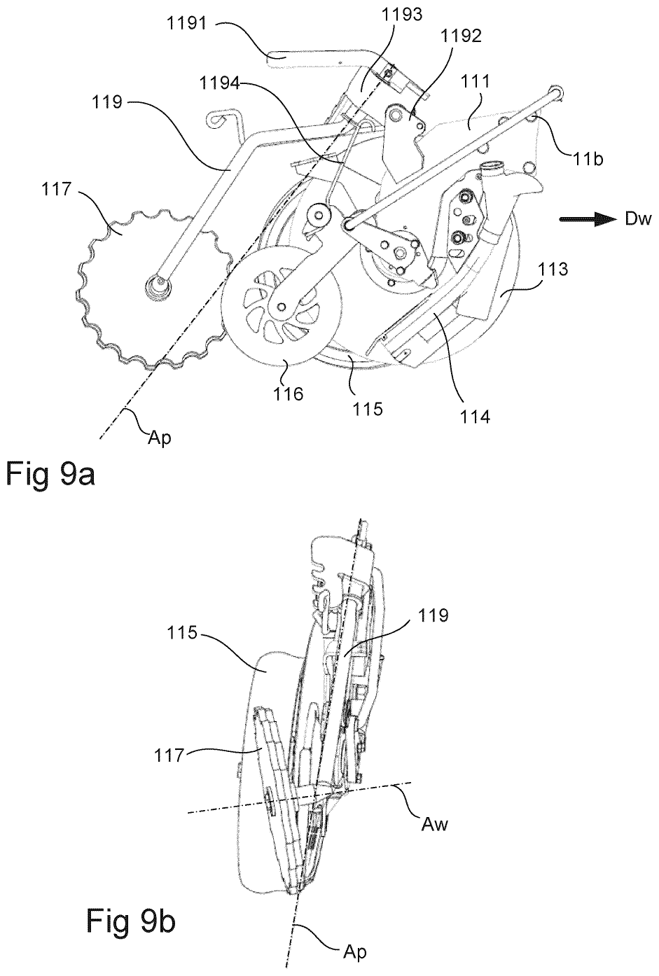

FIGS. 9a-9b schematically illustrate a row unit 110b according to this embodiment configured for the rear frame part 11b, in which a closing wheel 117 is in a position that is suitable for operation on very soft soil.

As can be seen in FIG. 9a, the geometric pivot axis Ap is inclined forwardly in a working direction relative to a vertical direction when the row unit is positioned on a horizontal surface. A connecting frame 1192, 1193 may be connected to the first row unit frame part 111 and may carry a closing wheel frame 119 and a closing wheel 117. The connecting frame 1192, 1193 has a first connecting frame part 1192 mounted to the row unit frame 111 and a second connecting frame part 1193 pivotably connected to the first connecting frame part 1192. Hence, the second connecting frame part 1193 is pivotable about a horizontal geometric axis which extends transversely relative to the working direction Dw, such that the closing wheel frame 119 can swing upwardly/backwardly in the event of the closing wheel striking an obstacle, such as a stone.

The closing wheel frame 119 may be biased towards a desired position. For example, the closing wheel frame 119 may be biased towards a neutral position or it may be downwardly biased. To this end, a spring 1194 may be provided.

The closing wheel 117 is supported by the closing wheel frame 119, which is pivotably connected to the first connecting frame part 1193 such that the closing wheel frame 119 is pivotable relative to the first connecting frame part 1193 about a geometric pivot axis Ap, which is inclined forwardly relative to a vertical direction when the row unit 110a, 110b is positioned on a horizontal surface.

The closing wheel 117 is rotatably connected to the closing wheel frame 119, such that the closing wheel 117 is rotatable about a geometric closing wheel axis Aw as can be seen in FIG. 9b.

The closing wheel frame 119 is adjustable by a handle 1191 so as to pivot about the axis Ap, whereby the position of the closing wheel 117 can be adjusted dependent on the soil. The positioning of the mechanism for adjusting the closing wheel 117 is higher up from the ground that in previous embodiments, thereby allowing for a better working position for the person adjusting the position of the closing wheel frame 119. The handle 1191 may be positioned above the furrow opener 113 and the gauge wheel 115. The position of the handle 1193 above the other tools of the row unit 110a, 110b allows for the person using the equipment to get an overview of the setting of the handles 1193 of the row units 110a, 110b without having to walk past and checking each and every row unit 110a, 110b close by.

A locking mechanism may be provided for locking the closing wheel frame 119 in a desired rotational position about the axis Ap. The desired position may be selected from at least two different rotational positions. Hence, in some embodiments, the locking mechanism may provide two or more fixed locking positions. In other embodiments, the locking mechanism may provided for a continuum of locking positions.

The locking mechanism may comprise a locking pin which selectively engages locking recesses or holes on at least one of the parts.

Alternatively, the locking mechanism may comprise a friction lock which may be engaged by a threaded member.

In particular, the geometric pivot axis Ap may be inclined such that, when the row unit 110a, 110b is positioned on a horizontal surface S and the closing wheel 117 rests on said surface S, an extension of the geometric pivot axis Ap intersects the horizontal surface S at a position which approximately coincides with a contact point between the closing wheel 117 and the horizontal surface S.

Consequently, when the closing wheel frame 118 is pivoted about the geometric pivot axis Ap, the closing wheel will essentially retain its position behind forwardly oriented parts of the row unit 110a, 110b, in particular the furrow opener 113, gauge wheel 115 and press wheel 116, if any.

The intersection point may be positioned at a distance from the contact point, which may be equal to or less than an 150% of an axial width of the closing wheel, preferably less than or equal to 100% of said axial width, less than or equal to 50% of said axial width or less than or equal to 10% of said axial width.

The intersection point may be positioned slightly laterally of and/or forwardly of the contact point. That is, the intersection point should be positioned such that the closing wheel 117 does not move forwardly when it is adjusted.

The geometric pivot axis may provide an angle of 5-60 degrees to a vertical direction, preferably 5-50 degrees or 10-40 degrees.

In particular, the angle may be in an interval selected from a group consisting of 5-10 degrees, 10-15 degrees, 15-20 degrees, 20-25 degrees, 25-30 degrees, 30-35 degrees, 35-40 degrees, 40-45 degrees, 45-50 degrees, 50-55 degrees and 55-60 degrees.

1-18. (canceled)

19. A row unit for an agricultural implement, comprising:
a row unit frame,
at least one furrow opener, supported by the row unit frame, and
at least one closing wheel, supported by the row unit frame,
the closing wheel being rotatably mounted to a closing wheel frame about a geometric rotation axis,
the closing wheel frame being pivotably mounted to the row unit frame,
the closing wheel frame is pivotably mounted to the row unit frame such that the closing wheel frame is pivotable about a geometric pivot axis which is inclined relative to a vertical direction,
the geometric pivot axis is inclined such that, when the row unit is positioned on a horizontal surface and the closing wheel rests on said surface, an extension of the geometric pivot axis intersects the horizontal surface at a position which approximately coincides with a contact point between the closing wheel and the horizontal surface.

20. The row unit as claimed in claim 19, wherein the intersection point is positioned laterally of and/or forwardly of the contact point.

21. The row unit as claimed in claim 20, wherein the intersection point is positioned at a distance from the contact point, which is equal to or less than an 150% of an axial width of the closing wheel, preferably less than or equal to 100% of said axial width, less than or equal to 50% of said axial width or less than or equal to 10% of said axial width.

22. The row unit as claimed in claim 21, wherein the intersection point is within a radius of less than 100 mm, preferably less than 70 mm, less than 50 mm or less than 25 mm, from the contact point.

23. The row unit as claimed in claim 19, wherein the geometric pivot axis provides an angle of 5-60 degrees to a vertical direction, preferably 5-50 degrees or 10-40 degrees.

24. The row unit as claimed in claim 19, wherein the geometric pivot axis is positioned in a first vertical plane which is parallel with a working direction of the row unit.

25. The row unit as claimed in claim 19, wherein a second plane which is perpendicular to the first vertical plane, and which contains the geometric pivot axis, is positioned rearwardly of an intersection of the geometric rotation axis and the closing wheel.

26. The row unit as claimed in claim 19, wherein the closing wheel is positionable in a first position wherein the closing wheel is rotatable in a vertical plane which contains a working direction of the row unit.

27. The row unit as claimed in claim 19, further comprising a locking device for releasably locking the closing wheel frame relative to the row unit frame in at least two predetermined relative positions.

28. The row unit as claimed in claim 19, further comprising a connecting frame for connecting the closing wheel frame to the row unit frame.

29. The row unit as claimed in claim 19, wherein the closing wheel frame further comprises a handle for adjusting the position of the closing wheel.

30. The row unit as claimed in claim 19, wherein the closing wheel frame is pivotably mounted to the row unit frame at a pivot joint which is positioned rearwardly of the geometric rotation axis.

31. The row unit as claimed in claim 30, wherein the geometric pivot axis is inclined such that a vertically upper portion of the geometric pivot axis is positioned horizontally rearwardly in the working direction of a vertically lower portion of the geometric pivot axis.

32. The row unit as claimed in claim 19, wherein the closing wheel frame is pivotably mounted to the row unit frame at a pivot joint which is positioned forwardly of the geometric rotation axis.

33. The row unit as claimed in claim 32, wherein the geometric pivot axis is inclined such that a vertically upper portion of the geometric pivot axis is positioned horizontally forwardly in the working direction of a vertically lower portion of the geometric pivot axis.

34. An agricultural implement for distribution of granular material to ground over which the implement travels, comprising:
an implement frame, and
a plurality of row units as claimed in claim 19, said row units being supported by the implement frame.

35. A method of adjusting an orientation of a closing wheel in a row unit comprising:
a row unit frame,
at least one furrow opener, supported by the row unit frame, and
at least one closing wheel, supported by the row unit frame, the closing wheel being rotatably mounted to a closing wheel frame about a geometric rotation axis (Aw), and the closing wheel frame being pivotably mounted to the row unit frame such that the closing wheel frame is pivotable about a geometric pivot axis (Ap) which is inclined relative to a vertical direction,
the row unit further comprises a locking device for releasably locking the closing wheel frame relative to the row unit frame in at least two predetermined relative positions,
the method comprising:
releasing the locking mechanism,
adjusting the orientation of the closing wheel by pivoting the closing wheel frame about the geometric pivot axis, and
subsequently engaging the locking mechanism.
